(19) United States
(12) Patent Application Publication
(10) Pub. No.: US 2026/0243516 A1
(43) Pub. Date: Aug. 20, 2026

(54) PARALLEL-FLOW REGENERATIVE SHAFT KILN AND METHOD OF BURNING CARBONATE ROCK

(71) Applicants: Maerz Ofenbau AG, Zurich (CH); thyssenkrupp Polysius GmbH, Beckum (DE); thyssenkrupp AG, Essen (DE)

(72) Inventors: Hannes PIRINGER, Beinwil am See (CH); Patrick BUCHER, Schoenenwerd (CH); Heinrich Theodor LUETTEN, Grueningen (CH)

(73) Assignees: Maerz Ofenbau AG, Zurich (CH); thyssenkrupp Polysius GmbH, Beckum (DE); thyssenkrupp AG, Essen (DE)

(21) Appl. No.: 19/152,842

(22) PCT Filed: Jan. 29, 2024
(86) PCT No.: PCT/EP2024/052024

§ 371 Date: Jul. 31, 2025

(30) Foreign Application Priority Data
Feb. 1, 2023 (BE) BE 2023/5064
Feb. 1, 2023 (DE) 10 2023 102 447.7

(51) Int. Cl. F27B 1/00; F27B 1/04; F27B 1/22; F27B 1/24

(52) U.S. Cl. CPC F27B 1/005; F27B 1/04; F27B 1/22; F27B 1/24

(57) ABSTRACT

A co-current/counter-current regenerative shaft kiln for burning and cooling material, such as carbonate rock, has two shafts which are operable alternately as a burning shaft and as a regenerative shaft and are connected to one another by means of a connecting duct, wherein in the flow direction of the material each shaft comprises a preheating zone for preheating the material, a burning zone for burning the material and a cooling zone for cooling the material, wherein the cooling zone comprises a cooling gas inlet for admitting cooling gas into the cooling zone and a cooling gas removal device for discharging cooling gas from the shaft, wherein configured downstream of the burning zone in the flow direction of the material is an after-calcination zone which is configured and adapted such that it effects after-calcination of the material exiting the burning zone at a gas temperature of 800° C. to 1100° C., especially 900° C. to 1000° C., preferably about 850° C. to 950° C.

The invention relates to a co-current/counter-current regenerative shaft kiln (PFR shaft kiln), and to a method of burning and cooling material, such as carbonate rock, with a PFR shaft kiln.

Burning of carbonate rock in a PFR shaft kiln has been known for about 60 years. A PFR shaft kiln of this kind, which is known for example from WO 2011/072894A 1 , has two vertical, parallel shafts in cyclical operation, with burning only in one shaft, the respective burning shaft, while the other shaft works as a regenerative shaft. The burning shaft is supplied with oxidation gas in cocurrent with the material and fuel, and the resultant hot offgases, together with the heated cooling air which is supplied from below, are conducted via the crossover duct into the offgas shaft, where the offgases are conducted away upward in countercurrent to the material and at the same time preheat the material. The material is typically supplied to the shaft from above together with the oxidation gas, with injection of fuels in the burning zone.

In each shaft, the material to be burned typically passes through a preheating zone for preheating of the material, a downstream burning zone in which the material is burned, and a downstream cooling zone in which cooling air is supplied to the hot material.

In order to meet the quality demands with respect to high reactivity of the burnt lime, as required for example in steelworks, the temperatures in the burning zone must not exceed a value of 1100° C., preferably 1000° C. Furthermore, demand for environmentally friendly production of burnt lime is also increasing, and so certain requirements for the CO₂ content of the offgas for subsequent aftertreatment must be met. A high degree of calcination of the end product is also desired.

It is accordingly an object of the present invention to provide a PFR shaft kiln and a method of burning carbonate rock with a PFR shaft kiln which makes it possible produce lime having a high reactivity and a high degree of calcination, wherein the offgas simultaneously has a high CO₂ content to allow cost-effective separation from the offgas.

This object is achieved according to the invention by an apparatus having the features of independent apparatus claim 1 and by a process having the features of independent process claim 12. Advantageous refinements are derived from the dependent claims.

In a first aspect the invention comprises a co-current/counter-current regenerative shaft kiln for burning and cooling material, such as carbonate rock, having two shafts which are operable alternately as a burning shaft and as a regenerative shaft and are connected to one another by means of a connecting duct, wherein in the flow direction of the material each shaft comprises a preheating zone for preheating the material, a burning zone for burning the material and a cooling zone for cooling the material. The cooling zone comprises a cooling gas inlet for admitting cooling gas into the cooling zone and a cooling gas removal device for discharging cooling gas from the shaft. Configured downstream of the burning zone in the flow direction of the material is a after-calcination zone which is configured and adapted such that it effects after-calcination of the material exiting the burning zone at a gas temperature of 800° C. to 1100° C., especially 900° C. to 1000° C., preferably about 850° C. to 950° C.

The after-calcination zone preferably immediately follows the burning zone. Each shaft preferably comprises a flow passage into the connecting duct, wherein the after-calcination zone is especially entirely configured downstream of the flow passage in the flow direction of the material. The flow passage into the connecting duct is preferably arranged in the burning zone or at the transition between the burning zone and the after-calcination zone. The after-calcination zone extends for example from the flow passage in the flow direction of the material. The material to be burned is preferably limestone or dolomite rock having a grain size of 10 to 200 mm, preferably of 15 to 120 mm, most preferably 30 to 100 mm. The cooling gas is air, for example.

The after-calcination zone is preferably arranged between the burning zone and the cooling zone so that after the burning zone the material is passed directly into the after-calcination zone and subjected to after-calcination therein. During after-calcination the material fractions not yet calcined in the burning zone are subsequently calcined, wherein the gas temperature within the after-calcination zone is lower than in the burning zone but higher than the calcining temperature of the material.

Each shaft preferably has a material inlet for admitting material to be burned into the shaft, where the material inlet is in particular at the upper end of the respective shaft, such that the material falls into the respective shaft under gravity. The material inlet and/or the material outlet is/are in particular in the form of a lock for admitting and/or discharging material into the shaft kiln. A material inlet in the form of a lock is preferably designed such that only the raw material to be burned gets into the shaft, but not the ambient air. The material lock also prevents gas from escaping from the shaft via the material inlet. The lock is preferably designed to seal the shaft airtight against the environment and to allow solids, such as the material to be burned, to enter the shaft.

The connecting duct is designed for gaseous connection of the two shafts and preferably connects the burning zones of the shafts to one another. The flow passage is preferably connected to the connecting channel 19 for gaseous connection of the shafts to one another and is especially arranged at the lower end of the burning zone with the result that the fuel gases flow from the burning zone into the flow passage. The after-calcination zone is preferably arranged between the burning zone and the flow passage in the flow direction of the fuel gases with the result that the fuel gases flow from the burning zone into the after-calcination zone, are preferably deflected therein and downstream of the after-calcination zone are directly introduced into the flow passage.

In the course of operation of the PFR shaft kiln, one of the shafts at a time is operated as a burning shaft and is active, while the respective other shaft is operated as a regenerative shaft and is passive. The PFR shaft kiln is in particular operated in cycles, with switching of the function of the shafts after the cycle time has elapsed. This procedure is repeated continuously. In the active shaft operated as burning shaft, a fuel is introduced into the burning zone via the burner lances. The material to be burned is heated in the preheating zone of the burning shaft, preferably to a temperature of about 700° C. In the shaft operated as burning shaft, the burning zone is in the form of a cocurrent burning zone, where the material to be burned flows parallel to the gas. The gas flows within the burning shaft from the preheating zone into the burning zone and then into the after-calcination zone and via the connecting duct into the burning zone and the preheating zone of the regenerative shaft. In the shaft operated as regenerative shaft, the gas flow in the preheating zone and the burning zone is in countercurrent to the material to be burned.

Both in the burning shaft and in the regenerative shaft, cooling gas is passed through the cooling zone in countercurrent to the material to be cooled and is preferably discharged completely from the shaft via the cooling gas outlet of the cooling gas removal device, such that there is preferably no flow of cooling gas from the cooling zone into the burning zone and the after-calcination zone.

Each shaft preferably has at least one offgas outlet, for example at the upper end of the shaft within the preheating zone. The offgas outlet is preferably disposed above the material column in a material-free region of the preheating zone. The offgas is preferably discharged exclusively from one shaft, in particular the regenerative shaft. The discharged offgas is preferably supplied to the respective other shaft, especially the burning shaft and/or the regenerative shaft, wherein the supplying is effected for example via the connecting duct or inlets in the shaft walls at the height of the burning zone. Preferably, only a portion of the offgas discharged from the regenerative shaft is returned to at least one shaft. A portion of the offgas discharged from the regenerative shaft is, for example, discharged from the PFR shaft kiln and supplied, for example, to a further treatment, such as a sequestration. The offgas preferably consists of CO₂ and optionally H₂O. The offgas discharged from the shaft preferably has a CO₂content of more than 90%, especially 95% to 99%, preferably 98%.

Recycling the offgas into at least one shaft allows production of lime having a high reactivity while simultaneously producing process gas having a CO₂ content of more than 90% based on dry gas. Such a process offgas enables liquefaction and sequestration thereof with a relatively low level of complexity. For example, the liquefied process offgas is supplied to further process steps or stored. The above-described PFR shaft kiln may alternatively be used to produce offgas having a lower CO₂ content, for example 45% for soda production or 35% for sugar production or 30% for production of precipitated calcium carbonate.

The offgas is for example introduced into the preheating zone or the burning zone of the shaft operated as the burning shaft and/or into the connecting duct and/or into the burning zone or preheating zone of the shaft operated as the regenerative shaft. Each shaft preferably has a gas inlet, in particular a combustion gas inlet, which is arranged in the upper region of the shaft in the preheating zone or the burning zone and serves for the admission of the gas required for combustion. The offgas discharged from the shaft via the offgas outlet preferably has a temperature of about 60° C.-160° C., especially 100° C. It is preferable when only a portion of the offgas is introduced into the preheating zone or the burning zone of the burning shaft. Recycling the offgases into the preheating zone makes it possible to increase the gas amount in the shaft while simultaneously ensuring a high CO₂ concentration in the offgas.

Before introduction to the shaft, especially into the connecting duct or into the burning zone of the shaft operated as the regenerative shaft or the burning shaft, the offgas is for example heated especially to a temperature of 900° C. to 1100° C., preferably 1000° C.

The cooling gas heated in the cooling zone is for example discharged from the cooling zone of the shaft via a cooling gas removal device. In particular, the cooling gas admitted into the cooling zone is fully discharged from the respective shaft via the cooling gas removal device. The cooling gas is preferably admitted into the cooling zone from below via a cooling gas inlet arranged in the lower region of the cooling zone. The cooling gas removal device preferably has a cooling gas outlet for discharging the cooling gas from the shaft. The cooling gas outlet is especially connected to a cooling gas removal conduit for conducting the removed cooling gas.

The shaft operated as a burning shaft is preferably supplied with an oxidant. The oxidant is for example pure oxygen or oxygen-rich gas having a proportion of oxygen of at least 70% to 95%, preferably 90%. The oxidant is preferably introduced into the preheating zone of the burning shaft together with the offgas. It is also conceivable for the shaft to have, in the preheating zone, a separate oxidant inlet for admitting the oxidant into the shaft separately from the offgas. The oxidant is preferably supplied to the burning zone together with the fuel. The oxidant conduit preferably has a control element, such as a valve or a flap, which can be used to adjust the amount of oxidant in the respective shaft.

The shafts preferably each comprise at least one burner lance, wherein the offgas is for example introduced into the burner lance. Each shaft preferably has a multiplicity of burner lances which extend at least partly through the preheating zone and in particular open into the burning zone of the respective shaft and serve to conduct, for example, fuel and/or an oxidant gas, such as air or oxygen-enriched air or pure oxygen. A fuel is preferably supplied to the burning zone and/or the preheating zone of the shaft operated as a burning shaft via a fuel conduit. The fuel is preferably supplied via burner lances arranged in the burning zone and/or the preheating zone. The fuel is for example a fuel gas, such as blast furnace gas or natural gas, or coal dust or biomass or liquid fuels. The material is preferably heated to a temperature of about 1100° C. in the burning zone. The offgas is especially introduced into the fuel conduit. To this end the offgas conduit is preferably connected to the fuel conduit and/or the at least one burner lance. The offgas is preferably introduced into the burner lance and/or the fuel conduit downstream of the heat exchanger, wherein the heat exchanger is preferably the heat exchanger for heating the offgas in countercurrent to the removed cooling gas. The offgas is preferably introduced into the burner lance and/or the fuel conduit via a control element, such as a flap or a valve, in order to adjust the amount of offgas in said burner lance and/or fuel conduit. Each fuel conduit and/or burner lance is preferably assigned a control element for adjusting the amount of offgas in the respective burner lance and/or fuel conduit. The control element is preferably arranged in the offgas conduit. The offgas is especially introduced into the burner lances of the shaft operated as a burning shaft.

In a first embodiment the after-calcination zone is at least partially or completely in the form of an annular space between the cooling gas removal device and the shaft wall. It is preferable when only a very small proportion of cooling gas, if any, is present in the after-calcination zone.

In a further embodiment a gas separation zone for separating the cooling gas and the fuel gas is configured between the after-calcination zone and the cooling zone. The gas separation zone preferably serves for gaseous separation of the cooling zone from the burning zone and the after-calcination zone. It is preferable when the gas separation zone is directly downstream of the after-calcination zone in the flow direction of the material, wherein the cooling zone is especially directly downstream of the gas separation zone. The gas separation zone is especially arranged in a shaft section having a substantially constant cross section. It is preferable when exclusively cooling gas from the cooling zone is introduced into the gas separation zone, wherein only a very small proportion of fuel gas, if any, for instance 0.5% to 10%, especially 1% to 8%, preferably 2% to 6%, is passed from the burning zone into the gas separation zone.

The configuration of the after-calcination zone and optionally of the gas separation zone prevents reliable separation of the cooling gases and the fuel gases, thus avoiding recarbonization. The after-calcination of the material simultaneously achieves a high degree of calcination.

In a further embodiment the after-calcination zone has a length extending in the flow direction of the material, wherein the cooling zone is configured as an annular space around the cooling gas removal device and has an external diameter and wherein the ratio of the length of the after-calcination zone and the external diameter of the cooling zone Ln/D1 is for instance 0.4 to 0.8, especially 0.5 to 0.7, preferably 0.6. This ratio ensures reliable and complete deflection of the fuel gases from the burning zone within the after-calcination zone so that only a very small proportion of fuel gases, if any, enters the gas separation zone or the cooling zone and virtually complete calcination of the material is effected. The after-calcination zone, the gas separation zone and the cooling zone are for example annular spaces, each having an external diameter and an internal diameter.

In a further embodiment the after-calcination zone has a length extending in the flow direction of the material, wherein the flow passage is configured as a material-free annular space and has an external diameter and wherein the ratio of the length of the after-calcination zone and the external diameter of the flow passage Ln/D5 is for instance 0.3 to 0.7, preferably 0.4 to 0.6, in particular 0.5. In its upper region for example the after-calcination zone has a greater cross section than the burning zone, wherein the cross section of the after-calcination zone especially reduces in the flow direction of the material. The burning zone preferably extends with its lower region into the upper region of the after-calcination zone, thus forming a flow passage in the form of an annular channel between the two shaft sections. The annular channel flow passage preferably forms a material-free space which contains no material to be burned. The flow channel preferably extends circumferentially around the lower region of the burning zone. The shafts for example each have a flow passage configured as an annular channel which is in each case gaseously connected to the connecting channel and arranged at the same height as said channel.

In a further embodiment the after-calcination zone configured as an annular space has an external diameter which reduces at an angle to the vertical of 0° to 30°, especially 5° to 20°, preferably 10°, in the flow direction of the material and/or wherein the after-calcination zone has an internal diameter which reduces at an angle to the vertical of 15° to 50°, especially 25° to 35°, preferably 28°, in the flow direction of the material. This ensures optimal gravity-mediated material transport within the after-calcination zone, thus preventing a backlog in the annular space and thus avoiding dust deposits and dust encrustations.

In a further embodiment the cooling gas removal device comprises an inner cylinder having a cooling gas inlet arranged within the cooling zone. The cooling gas removal device moreover preferably has a cover, wherein the cover is arranged upstream of the cooling gas inlet in the flow direction of the material. The cover therefore reliably prevents entry of material into the inner cylinder. The inner cylinder is preferably configured as a hollow cylinder and especially extends centrally, preferably coaxially to the cooling zone, through said zone, especially to the height of the after-calcination zone. The inner cylinder is preferably gaseously connected to the cooling gas outlet for discharging the cooling gas from the shaft.

In a further embodiment the cooling gas removal device comprises a particle separation apparatus for separating material particles from the cooling gas stream. It is preferable when the particle separation apparatus is arranged upstream of the cooling gas inlet into the inner cylinder of the cooling gas removal device in the flow direction of the gas. A particle separation apparatus prevents material entry into the inner cylinder of the cooling gas removal device, thus avoiding blockage of the cooling gas removal device. It is preferable when material particles, preferably of more than 0.3 mm in size, are separated from the gas stream before admittance of the cooling gas into the inner cylinder.

In a further embodiment the particle separation apparatus is configured as a cooling air channel between the cover and the inner cylinder which opens into the cooling gas inlet. The particle separation apparatus, especially the cooling air channel, forms a gaseous connection of the inner cylinder to the cooling zone.

The cover is preferably arranged upstream of the cooling gas inlet in the flow direction of the material, thus forming a material-free space, especially the cooling air channel, around the cooling gas inlet. The cover preferably comprises a first, lower, region which is in the form of a hollow cylinder and extends around the inner cylinder coaxially therewith. The first region preferably has a constant cross section, especially internal diameter. The first region preferably terminates at about the same height as, or above, the cooling gas inlet. Following at the upper end of the first region is for example a second region configured for example as a hollow cone whose tip is pointing upward. The internal diameter of the second region preferably narrows from the internal diameter of the first region counter to the material flow direction. The cone angle of the cover is preferably 15° to 50°, especially 25° to 35°, preferably 28°, to the vertical.

The cooling air channel preferably comprises an annular region between the first region of the cover and a hollow-conical region between the second region and the inner cylinder. The cooling air channel is especially configured such that the cooling air is deflected at an angle of 90° to 200°, especially 120° to 180°, before it enters into the cooling gas inlet of the inner cylinder. The particle separation apparatus in the form of a cooling air channel ensures that only particles smaller than about 0.3 mm of the material to be cooled, if any, pass into the inner cylinder.

In a further embodiment the cooling air channel is configured such that the cooling air is deflected at an angle of 90° to 200°, especially 120° to 180°, preferably 180°. This ensures reliable particle separation.

In a further embodiment the cooling gas removal device is connected to a heat exchanger for heating the offgas. The PFR shaft kiln comprises for example a heat exchanger which is gaseously connected to the offgas outlet and the cooling gas removal device with the result that the offgas is heated in countercurrent to the cooling gas. The heat exchanger is for example a heat exchanger in the form of a regenerator or a heat exchanger in the form of a recuperator. The recuperator is for example a plate heat exchanger or a shell-and-tube heat exchanger. The cooling gas discharged from the cooling zone is preferably supplied to the heat exchanger for heating the offgas. Before being introduced into the connecting channel and/or the burning zone of the regenerative shaft, the offgas removed via the offgas outlet is preferably heated in countercurrent by the removed cooling gas. The offgas is preferably heated to a temperature of 400° C. to 800° C., especially 600° C., by means of the heat exchanger.

The invention further relates to a method of burning material, such as carbonate rock, in a co-current/counter-current regenerative shaft kiln having two shafts which are operated alternately as a burning shaft and as a regenerative shaft and are connected to one another by means of a connecting duct, wherein the material flows through a material inlet into a preheating zone for preheating the material, a burning zone for burning the material and a cooling zone for cooling the material to a material outlet, wherein a cooling gas is admitted into the cooling zone and wherein the cooling gas heated in the cooling zone is discharged from the cooling zone of the shaft via a cooling gas removal device and wherein the burning zone is gaseously connected to the connecting duct. The material exiting from the burning zone is subjected to after-calcination in a after-calcination zone downstream of the burning zone in the flow direction of the material at a gas temperature of 800° C. to 1100° C., especially 900° C. to 1000° C., preferably about 850° C. to 950° C.

The burning zone is especially gaseously connected to the connecting duct by means of a flow passage. The material exiting the burning zone is preferably subjected to after-calcination in a after-calcination zone downstream of the flow passage in the flow direction of the material. The after-calcination zone preferably immediately follows the burning zone with the result that the material is immediately subjected to after-calcination in the after-calcination zone after the burning zone.

The embodiments and advantages described with reference to the co-current/counter-current regenerative shaft kiln also apply to the method in a corresponding manner for a method.

In one embodiment the cooling air is introduced into the cooling gas removal device at a temperature of less than 900° C., especially 700° C. to 850° C., preferably 725° C. to 800° C. The PFR shaft kiln is preferably configured and adapted such that the cooling air discharged from the shaft via the cooling gas removal device has a temperature of less than 900° C., especially 700° C. to 850° C., preferably 725° C. to 800° C. In a further embodiment the cooling gas discharged from the cooling zone is supplied to a heat exchanger for heating the offgas, wherein the cooling gas removal device is preferably connected to the heat exchanger, with the result that the removed cooling air is supplied to the heat exchanger at a temperature of less than 900° C., especially 700° C. to 850° C., preferably 725° C. to 800° C. This reliably prevents caking and contamination of the heat exchanger and ensures optimum operation and heat exchange with the offgas.

In a further embodiment a cooling gas content of 0.5% to 10%, especially 1% to 8%, preferably 2% to 6%, is established in the after-calcination zone. The cooling gas arriving in the after-calcination zone is preferably a slip of cooling gas which is unavoidable from a process engineering standpoint. The latter is preferably low enough to be negligible. Recarbonization of the material is thus almost entirely prevented.

In a further embodiment the fuel gas is deflected at an angle of 90° to 180°, preferably 120° to 150°, in the after-calcination zone. The after-calcination zone is preferably configured and adapted such that the fuel gas is deflected at an angle of 90° to 180°, preferably 120° to 150°. The deflection of the fuel gas is preferably effected exclusively in the after-calcination zone and not in the burning zone, the cooling zone or the gas separation zone.

### DESCRIPTION OF THE DRAWINGS

The invention shall be more particularly elucidated below by way of a number of exemplary embodiments with the reference to the accompanying figures.

FIG. 1 shows a schematic diagram of a PFR shaft kiln in a sectional view with a perspective view of the cooling gas removal device according to an exemplary embodiment.

FIG. 2 shows a schematic diagram of a PFR shaft kiln in a sectional view according to the exemplary embodiment of FIG. 1.

FIG. 3a shows a schematic diagram of a PFR shaft kiln in a sectional view according to a further exemplary embodiment.

FIG. 3b shows a schematic diagram of a subsection of a PFR shaft kiln in a sectional view according to a further exemplary embodiment.

FIGS. 4a-c show a schematic diagram of a PFR shaft kiln in a cross sectional view in the sectional planes of FIG. 3a according to a further exemplary embodiment.

FIG. 5 shows a schematic diagram of a PFR shaft kiln in a sectional view according to any of FIGS. 1 to 3.

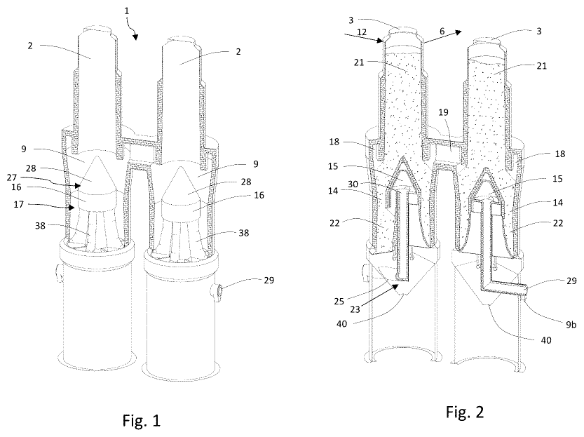

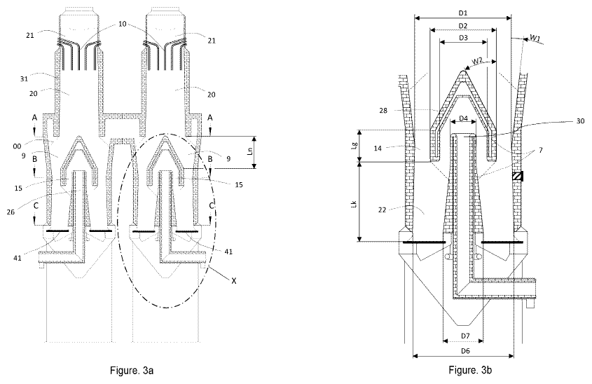

FIGS. 1 and 2 each show a PFR shaft kiln 1, having two parallel and vertically oriented shafts 2. The shafts 2 of the PFR shaft kiln 1 are of essentially identical construction, and so only one of the two shafts 2 is given reference signs in FIG. 1 and only one of the two shafts 2 is described below for the sake of simplicity. Each shaft 2 has a respective material inlet 3 for admitting material to be burned into the respective shaft 2 of the PFR shaft kiln 1. The material to be burned is in particular limestone and/or dolomite rock, preferably having a grain size of 10 to 200 mm, preferably of 15 to 120 mm, most preferably 30 to 100 mm. By way of example, the material inlets 3 are disposed at the upper end of the respective shaft 2, such that the material falls through the material inlet 3 into the shaft 2 under gravity. The material inlet 3 takes the form, for example, of an upper opening in the shaft 2 and in particular that of a lock 3, and preferably extends over the entirety or a portion of the cross section of the shaft 2. A material inlet in the form of a lock 3 is preferably configured such that only the raw material to be burned gets into the shaft 2, but not the ambient air. The lock 3 is preferably configured such that it seals off the shaft 2 against the environment in an airtight manner and allows solids, such as the material to be burned, to enter the shaft.

Each shaft 2 additionally has, at its upper end, a combustion gas inlet 12 for admitting combustion gas for combustion of fuels. The combustion gas is, for example, dedusted offgas from at least one of the shafts 2, with the offgas preferably being enriched with oxygen. Furthermore, each shaft 2 has an offgas outlet 6 for discharging offgases from the respective shaft 2. A respective control element is assigned to each offgas outlet 6 and combustion gas inlet 12 for example. The control elements, such as an adjustable-volume compressor, can preferably be used to adjust the amount of combustion gas in the respective combustion gas inlet 12 and the amount of offgas to be removed via the respective offgas outlet 6. The combustion gas inlet 12 and the offgas outlet 6 are arranged for example at the same height level and especially inside the preheating zone 21 of the respective shaft 2.

Arranged at the lower end of the shaft 2 is a material outlet 40 for discharging the burnt material. The material outlet 40 is, for example, a lock as described with reference to the material inlet 3.

The burned material is conducted, for example, into an outlet funnel 25 adjoined by the material outlet 40 of the shaft 2. By way of example, the outlet funnel 25 is funnel-shaped. The outlet funnel 25 preferably has a cooling gas inlet 23 for admitting cooling gas into the respective shaft 2. The cooling gas is preferably passed into the cooling gas inlet by means of a compressor (not shown).

In operation of the PFR shaft kiln 1 the material to be burned flows from top to bottom through the respective shaft 2 while the cooling air flows from bottom to top in countercurrent to the material partly through the respective shaft 2. The kiln offgas is discharged from the shaft 2 through the offgas outlet 6. The offgas discharged from the shaft 2 preferably has a CO₂ content of at least 80%, especially 90%-99%, preferably about 95%.

The preheating zone 21 of the respective shaft 2 adjoins in the direction of flow of the material below the material inlet 3 and the combustion gas inlet 12. The material and the combustion gas are preferably preheated to about 700° C. in the preheating zone 21. The respective shaft 2 is preferably filled with material to be burned. The material is preferably supplied to the respective shaft 2 above the preheating zone 21. At least a portion of the preheating zone 21 and the portion of the respective shaft 2 which adjoins it in flow direction of the material are surrounded, for example, by a refractory lining.

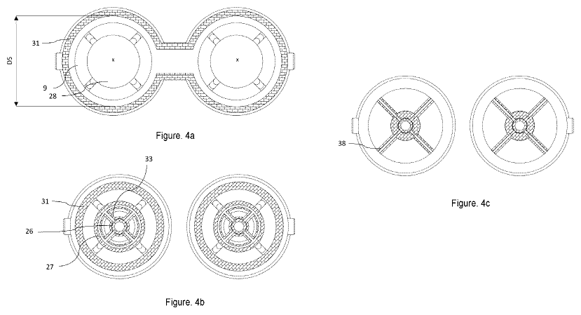

FIG. 3 shows a PFR shaft kiln according to FIGS. 1 and 2 in a detailed diagram, wherein in the preheating zone 21 optionally a plurality of burner lances 10 are arranged and each serve as an inlet for fuel, for example a fuel gas, oil or ground solid fuel. The PFR shaft kiln 1 has, for example, a cooling device for cooling the burner lances 10. The cooling device comprises, for example, a plurality of annular cooling air conduits which extend annularly around the shaft region in which the burner lances 10 are disposed. Cooling air for cooling of the burner lances 10 preferably flows through the annular cooling air conduits. Preferably, the burner lances 10 are cooled by means of the offgas discharged via the offgas outlet 6. The offgas outlet 6 is preferably connected to the burner lances 10 for conduction of offgas to the burner lances 10.

A plurality, for example twelve or more, of burner lances 10 are preferably arranged in each shaft 2 at a substantially uniform distance from one another. By way of example, the burner lances 10 have an L shape and preferably extend in a horizontal direction into the respective shaft 2 and in a vertical direction, in particular in the direction of flow of the material, inside the shaft 2. The ends of the burner lances 10 of a shaft 2 are preferably all arranged at the same height level. Preferably, the plane on which the lance ends are arranged is in each case the lower end of the respective preheating zone 21. The burner lances 10 are preferably connected to a fuel conduit (not shown) for conducting fuel to the burner lances 10. The fuel conduit is for example at least partly in the form of an annular conduit that extends circumferentially around the respective shaft 2. Preferably, each shaft 2 has a fuel conduit which is assigned in each case to the burner lances 10 of the shaft 2 and which in particular has a respective control element for adjusting the amount of fuel to the burner lances 10.

The preheating zone 21 is adjoined in flow direction of the material by the burning zone 20. In the burning zone 20, the fuel is combusted and the preheated material is burned at a temperature of about 1000° C. The PFR shaft kiln 1 also has a connecting duct 19 for gaseous connection of the two shafts 2 to one another. There is in particular no material to be burned in the connecting duct 19.

The PFR shaft furnace 1 preferably has in the flow direction of the material a preheating zone 21 for preheating the material, a burning zone 20 for burning the material, a after-calcination zone 9 for after-calcination of the material, a gas separation zone 14 for gaseous separation of the cooling zone from the burning zone and the after-calcination zone and a cooling zone 22 for cooling the material.

FIGS. 1-5 show for example a PFR shaft kiln 1 having round shaft cross-sections. However, the shaft cross section may have a different geometric outline, for example round, semicircular, oval, square or polygonal. The burning zone 20 extends for example in a shaft section which has a substantially constant or increasing cross section.

The burning zone 20 is preferably configured such that the fuel gases run parallel to the shaft axis within said zone. The burning zone 20 is preferably followed in the flow direction of the material by the after-calcination zone 9 which for example in its upper region has a larger cross section than the burning zone 20, wherein the cross section of the after-calcination zone 9 especially reduces in the flow direction of the material. The burning zone 20 preferably extends with its lower region into the upper region of the after-calcination zone 9, thus forming an annular channel 18 between the two shaft sections. The annular channel 18 preferably forms a material-free space in which no material to be burned is disposed. The annular channel 18 preferably extends circumferentially around the lower region of the burning zone 20. The shafts 2 of FIGS. 1-4 for example have respective annular channels 18 which are in each case connected to the connecting duct 19.

The after-calcination zone 9 preferably comprises a shaft region having a cross section which narrows in the flow direction of the material. It is preferable when the after-calcination zone 9 extends from the annular channel 18 in the flow direction of the material up to a shaft region having a constant cross section.

The gas separation zone 14 is arranged between the cooling zone 22 in the after-calcination zone 9 and preferably serves for gas separation of the cooling zone 22 from the burning zone 20 and the after-calcination zone 9. It is preferable when the gas separation zone 14 is immediately downstream of the after-calcination zone 9 in the flow direction of the material, wherein the cooling zone 22 is especially immediately downstream of the gas separation zone 14. The gas separation zone 14 is especially arranged in a shaft section having a substantially constant cross section.

The cooling zone 22 preferably extends up to the discharge device 41 and is especially configured in a shaft section having a substantially constant or downwardly narrowing cross section.

A discharge device 41 is preferably disposed at the material outlet end of each shaft 2. The discharge devices 41 include, for example, horizontal plates, preferably a discharge table, which allow the material to pass through laterally between the discharge table and the housing wall of the PFR shaft kiln. The discharge device 41 is preferably designed as a slide table or turntable or as a table with pushable scrapers. This enables a uniform throughput rate of the material to be burned through the shafts 2. By way of example, the discharge device 41 further comprises the outlet funnel 25, which adjoins the discharge table and has the material outlet 40 mounted at its lower end.

In operation of the PFR shaft kiln 1, one of the shafts 2 is active at any time, with the respectively other shaft 2 being passive. The active shaft 2 is referred to as burning shaft and the passive shaft 2 as regenerative shaft. The PFR shaft kiln 1 is in particular operated cyclically, with a typical number of cycles being 75 to 150 cycles per day, for example. After the cycle time has elapsed, the function of the shafts 2 is switched. This procedure is repeated continuously. Material such as limestone or dolomite rock is alternately supplied to the shafts 2 via the material inlets 3. In the active shaft 2 operated as burning shaft, a fuel is introduced into the burning shaft 2 via the burner lances 10. The material to be burned is heated to a temperature of about 700° C. in the preheating zone 21 of the burning shaft.

In operation of the PFR shaft kiln 1, both in the burning shaft 2 and in the regenerative shaft 2, the cooling gas flows through the cooling zone 22 in countercurrent to the material to be cooled and is preferably completely discharged from the shaft 2 via the cooling gas outlet 29, such that preferably no cooling gas flows from the cooling zone 22 into the burning zone 20.

Inside the shaft 2 operated as a burning shaft, the combustion gas flows through the combustion gas inlet 12 into the burning shaft and in cocurrent with the material inside the burning zone 20. The fuel gas flows from the burning zone 20 into the after-calcination zone 9 and is deflected within the after-calcination zone 9 with the result that it flows into the material-free space configured as annular channel 18. The gas flows from the material-free space 18 via the connecting duct 19 into shaft 2 operated as the regenerative shaft. Within the regenerative shaft the gas flows from the connecting duct 19 and the material-free space 18 of the regenerative shaft into the after-calcination zone 9 and is deflected therein with the result that in countercurrent to the material to be burned it flows through the burning zone 20 into the preheating zone 21 and exits the regenerative shaft through the offgas outlet 6 of the regenerative shaft. The offgas discharged from the shaft 2 is preferably at a temperature of 60° C. to 160° C., preferably 100° C.

The offgas is preferably passed into an offgas conduit which follows the offgas outlet 6. The offgas conduit optionally comprises an offgas filter for filtration of fine particles, especially dust, from the offgas especially downstream of the offgas outlet 6 in the flow direction of the offgas. A portion of the offgas is preferably passed to the fuel gas inlet 12 in a fuel gas conduit. It is preferable when the offgas is only supplied to the combustion gas inlet 12 of the shaft 2 operated as the burning shaft. The fuel gas conduit is especially connected to an oxidant conduit with the result that an oxidant, preferably pure oxygen, is introduced into the fuel gas conduit and then, together with the offgas, into the shaft 2 via the fuel gas inlet 12. It is likewise conceivable that the oxidant introduced into the combustion gas conduit 4 is an oxygen-rich gas having a proportion of oxygen of at least 70% to 95%, preferably 90%. It is likewise conceivable that a portion of the offgas is supplied to the burner lances. The portion of the offgas that is not recycled to the fuel gas inlet 12 is optionally supplied to the connecting duct 19 or the burner lances. The offgas conduit optionally comprises a heat exchanger for heating the offgas. The heat exchanger is for example in the form of a recuperator, wherein the offgas is heated in countercurrent to the removed cooling gas and the cooling gas is simultaneously cooled. The heat exchanger is especially connected to the cooling gas outlets 29 of both shafts 2 via a cooling gas removal conduit with the result that the offgas is preferably heated in countercurrent in the heat exchanger using the removed cooling gas.

It is preferable when a portion of the offgas is diverted and discharged. It is preferable when the entire CO₂ amount from the calcination and the burning and optionally the water from the burning are discharged from the PFR shaft kiln 1.

Each cooling zone 22 has a cooling gas removal device 17 having a respective cooling gas outlet 29 arranged in it. The cooling gas removal device 17 comprises an inner cylinder 26 which extends from the cooling zone 22 at least partially into the after-calcination zone 9 and the gas separation zone 14 and is connected to the cooling gas outlet 29. The inner cylinder 26 extends for example from the discharge device 41 through the cooling zone 22 and the gas separation zone 14 into the after-calcination zone 9 up to the height of the connecting duct 19. To cool the inner cylinder 26 the outer walls thereof preferably have a plurality of cooling channels 7 configured therein which are connected to a cooling air conduit for conducting cooling air. The inner cylinder 26 of the cooling gas removal device 17 comprises a cooling gas outlet 29 which is configured as a conduit and extends from the inner cylinder 26 downward centrally through the discharge device 41 and then radially outwardly through the discharge funnel 25 and the shaft wall 31 and serves for conducting cooling gas out of the inner cylinder 26 and out of the shaft 2.

The inner cylinder 26 is preferably configured to be open at the top and comprises at its upper end a cooling gas inlet 30 for admitting cooling gas from the cooling zone 22 into the inner cylinder 26. The inner cylinder 26 is preferably arranged coaxially to the shaft 2 within the cooling zone 22 and has for example a refractory lining 8 whose wall thickness especially increases in the flow direction of the material with the result that the internal diameter of the cooling zone configured as an annular space increases in the flow direction of the material. Above the inner cylinder 26 and for protection against ingress of material into the cooling gas inlet 30 the cooling gas removal device 17 has a cover 27. The cover 27 is arranged upstream of the cooling gas inlet 30 in the flow direction of the material, thus forming a material-free space, especially a cooling air channel 15, around the cooling gas inlet 30. The cooling air channel 15 is configured between the cover 27 and the inner cylinder 26.

The cover 27 for example comprises a first, lower, region 16 which is in the form of a hollow cylinder and extends around the inner cylinder 26 coaxially therewith. The first region 16 preferably has a constant cross section, especially internal diameter. The first region preferably terminates at about the same height as, or above, the cooling gas inlet 30. Following at the upper end of the first region 16 is a second region 28 configured for example as a hollow cone whose tip is pointing upward. The internal diameter of the second region preferably narrows from the internal diameter of the first region counter to the material flow direction. The first and second region 16, 28 form, for example, the one-piece cover 27. The cooling air channel 15 preferably comprises an annular region between the first region 16 of the cover 27 and a hollow-conical region between the second region 28 and the inner cylinder 26. The cooling air channel 15 is especially configured such that the cooling air is deflected at an angle of 90° to 200°, especially 120° to 180°, before it enters into the cooling gas inlet 30 of the inner cylinder 26. The cooling air channel 15 thus has the function of a particle separation chamber with the result that only very few particles, if any, of the material to be cooled pass into the inner cylinder 26. The cooling air channel 15 is preferably configured and adapted such that exclusively particles having a diameter of less than 0.4 mm to 0.5 mm, especially less than 0.3 mm, pass into the interior of the inner cylinder 26. The flow rate within the cooling air channel 15 has especially been established such that exclusively particles having a diameter of less than 0.4 mm to 0.5 mm, especially less than 0.3 mm, pass into the interior of the inner cylinder 26. The tip of the cover 27 is preferably arranged spaced apart from the lower end of the burning zone 20, wherein the spacing corresponds to about 0.5 to 1.5 times the length Ln of the after-calcination zone 9. It is also conceivable that the tip of the cover 28 is arranged at the height of the lower end of the burning zone 20.

The cover 27 has for example a plurality of cooling channels 7 which extend along the wall of the cover and serve for conduction of cooling fluid, preferably cooling air. The cover 27 is preferably at least partially formed from a refractory material.

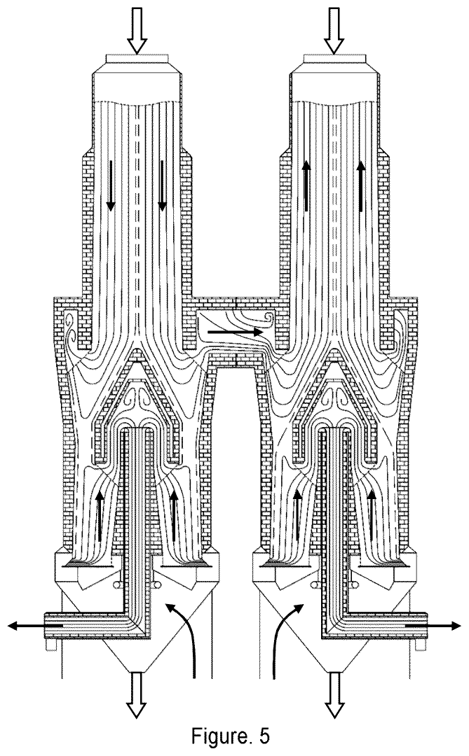

FIG. 4a shows a cross-section through a shaft 2 in the sectional plane A-A according to FIG. 3a which is at the height of the connecting channel 19 and the annular channel 18. The annular channel has a preferably constant internal diameter D5.

FIG. 4b shows a cross-section through a shaft 2 in the sectional plane B-B according to FIG. 3a. It is preferable when the cover 27, especially the second region 28, is attached to the inner cylinder 26 via radial struts 33. The cooling gas removal device 17 has for example four struts 33 which are especially uniformly circumferentially spaced apart from one another. The cooling gas channels 7 for example additionally extend through the struts 33.

The cooling gas removal device 17 preferably comprises a plurality of supporting elements 38 arranged within the cooling zone 22 according to FIGS. 1 and 2. The supporting elements 38 extend for example from the bottom of the cooling zone 22, especially from the discharge device 41 to the cover 27, wherein the cover 27 is especially supported on the supporting elements 38. FIG. 4c shows a cross section through a shaft 2 in the cross sectional plane C-C according to FIG. 3a, wherein in the exemplary embodiment four supporting elements 38 are arranged, which are preferably uniformly spaced apart from one another in the circumferential direction and optionally each comprise at least one cooling channel 7 for conducting cooling gas through the supporting elements 38. The supporting elements 38 are preferably all identically configured. The supporting elements 38 especially have an external diameter which increases in the flow direction of the material.

The cooling gas inlet 30 is preferably disposed above the cooling gas outlet 29 in the cooling zone 22. In operation of the PFR shaft kiln 1, the cooling gas flows from the bottom upward through the cooling zone 22 and into the cooling gas inlet 30 into the inner cylinder 26 of the cooling gas removal device 17. It is preferable when all of the cooling gas introduced into the cooling zone 22 flows through the cooling gas inlet 30 into the cooling gas removal device 17 so that no cooling gas passes into the after-calcination zone 9 and into the burning zone 20. The cooling air outlet 29 of the inner cylinder 26 is preferably disposed below the cooling zone 22. In particular, the cooling gas flows downward from the cooling gas inlet 30 in the inner cylinder 26 to the cooling gas outlet 29.

The after-calcination zone 9, the gas separation zone 14 and the cooling zone 22 are preferably configured as annular spaces around the cooling gas removal device 17, wherein the annular spaces each have an external diameter and an internal diameter.

The after-calcination zone 9 is preferably formed between the cover 27 of the cooling gas removal device 17 and the shaft wall 31. The after-calcination zone 9 is especially formed exclusively between the upper region 28 of the cover 27 and the shaft wall 31. The after-calcination zone 9 preferably has a length Ln in the flow direction of the material, wherein the cooling zone 22 has an external diameter D1 and wherein the ratio of the length Ln of the after-calcination zone 9 and the external diameter D1 of the cooling zone 22 (Ln/D1) is for instance 0.4 bis 0.8, especially 0.5 to 0.6. The annular channel 18 preferably has an external diameter D5 wherein the ratio of the length Ln of the after-calcination zone 9 and the external diameter D5 of the annular channel 18 (Ln/D5) is for instance 0.3 bis 0.7, preferably 0.4 to 0.6, especially 0.5.

In the after-calcination zone 9 it is preferable to establish a gas temperature of 900° C. to 1100° C., especially 850° C. to 1000° C., and/or a CO₂ content of at least 90%, especially at least 98%. At this temperature the material to be burned that was incompletely calcined in the burning zone 20 is subjected to after-calcination so that even in the case of a very CO₂-rich gas flow the material to be burned is subjected to after-calcination and only a negligible amount, if any, of recarbonization occurs, thus producing a good lime quality. The after-calcination zone 9 is preferably configured such that the fuel gas is especially deflected at an angle of 90° to 180°, preferably 120° to 150°.

In the after-calcination zone the shaft wall 31 preferably has an angle W1 to the vertical of 0° to 30°, especially 5° to 20°, preferably 10°. The second, conical region 28 of the cover 27 preferably has a cone angle W2 to the vertical of 15° to 50°, especially 25° to 35°, preferably 28°.

The gas separation zone 14 preferably has a length Lg extending in the flow direction of the material. The ratio of the internal diameter D2 of the gas separation zone 14 to the external diameter of the cooling zone D1 (D2/D1) is in particular for instance 0.4 to 0.9, preferably 0.5 to 0.8, especially 0.7. The external diameter of the gas separation zone preferably corresponds to the external diameter D1 of the cooling zone 22. The ratio of the length Lg of the gas separation zone 14 to the external diameter D1 of the cooling zone 22 in particular is 0 to 1, preferably 0.3.

The cooling zone 22 for example has an external diameter which increases in the flow direction of the material, especially up to the material discharge. The cooling zone 22 preferably has an external diameter D1 at its upper end and an external diameter D6 at its lower end, wherein the ratio between the lower and the upper external diameter D6/D1 is for instance 0.8 to 1.2, preferably 1.05. This ratio ensures that the material can readily and uniformly descend in the cooling zone 22 due to gravity and be readily discharged by the discharge device 41. The cooling zone 22 for example has an internal diameter which increases in the flow direction of the material, especially up to the material discharge. The cooling zone 22 preferably has an internal diameter D4 at its upper end and an internal diameter D7 at its lower end, wherein the ratio between the lower and the upper internal diameter D7/D4 is for instance 1 to 4, preferably 2 to 3. This ratio also ensures uniform descent of the material in the cooling zone 22.

The cooling gas is preferably removed from the cooling zone 22 via the cooling gas removal device 17 at a temperature of 900° C. to 650° C., especially 700° C. 750° C., preferably 725° C. The PFR shaft kiln 1 preferably has a heat exchanger that is connected to the cooling gas removal device 17 for supplying the removed cooling gas. This prevents adherence of dust to the inner walls of the cooling gas removal device 17 and to the downstream heat exchanger. The cooling gas is preferably supplied to the heat exchanger at a temperature of less than 750° C., thus enabling cost-effective operation of the heat exchanger. A further advantage is that the length Lk of the cooling zone 22 can be made smaller and thus more cost-effective when supplying an elevated amount of cooling air.

The lime produced with the previously described PFR shaft kiln 1 of FIGS. 1 to 4 has a high reactivity, with process gas having a CO₂ content of more than 90% based on dry gas being produced at the same time. Such a process offgas can be liquefied and sequestered with a relatively low degree of complexity. For example, the liquefied process offgas is supplied to further process steps or stored. Alternatively, the above-described PFR shaft kiln can be used to produce offgas having a lower CO₂ content, for example 45% for soda production or 35% for sugar production or 30% for the production of precipitated calcium carbonate.

FIG. 5 shows a schematic diagram of the PFR shaft kiln 1 of FIGS. 1 to 3, wherein the flows of the gas streams within the PFR shaft kiln are shown. For example the left-hand shaft is operated as the burning shaft and the right-hand shaft as the regenerative shaft. FIG. 5 shows that a deflection of the gas stream is effected in the after-calcination zone 9.

### LIST OF REFERENCE SIGNS

1 PFR shaft kiln
2 shaft
3 material inlet/lock
4 combustion gas conduit
6 offgas outlet
7 cooling channels
8 refractory lining
9 after-calcination zone
10 burner lances
11 cooling gas removal conduit
12 combustion gas inlet
14 gas separation zone
15 cooling air channel
16 first region of the cover
17 cooling gas removal device
18 annular duct/material-free space
19 connecting duct
20 burning zone
21 preheating zone
22 cooling zone
23 cooling gas inlet
24 further connecting duct of the cooling zones
25 outlet funnel
26 inner cylinder
27 cover
28 second region of cover
29 cooling gas outlet
30 cooling gas inlet
31 shaft wall
32 cooling device
33 struts
38 supporting elements
40 material outlet/lock
41 discharge device
Ln length of after-calcination zone
Lg length of gas separation zone
Lk length of cooling zone
D1 external diameter of cooling zone, upper end
D2 internal diameter of gas separation zone
D3 external diameter of cooling air channel
D4 internal diameter of cooling zone, upper end
D5 external diameter of annular channel
D6 external diameter of cooling zone, lower end
D7 internal diameter of cooling zone, lower end

1-15. (canceled)

16. A co-current/counter-current regenerative shaft kiln for burning and cooling material, such as carbonate rock, comprising:
two shafts which are operable alternately as a burning shaft and as a regenerative shaft and are connected to one another by means of a connecting duct;
wherein in the flow direction of the material each shaft comprises a preheating zone for preheating the material, a burning zone for burning the material and a cooling zone for cooling the material;
wherein the cooling zone comprises a cooling gas inlet for admitting cooling gas into the cooling zone and a cooling gas removal device for discharging cooling gas from the shaft;
wherein, configured downstream of the burning zone in the flow direction of the material is an after-calcination zone which is configured and adapted such that it effects after-calcination of the material exiting the burning zone at a gas temperature of 800° C. to 1100° C., wherein a gas separation zone for separating the cooling gas and the fuel gas is configured between the after-calcination zone and the cooling zone, wherein the gas separation zone is configured as an annular space, wherein the ratio of the internal diameter of the gas separation zone to the external diameter of the cooling zone is 0.4 to 0.9.

17. The co-current/counter-current regenerative shaft kiln as claimed in claim 16, wherein the after-calcination zone is at least partially configured as an annular space between the cooling gas removal device and the shaft wall.

18. The co-current/counter-current regenerative shaft kiln as claimed in claim 16, wherein the after-calcination zone has an external diameter which reduces at an angle W1 to the vertical of 0° to 30°, in the flow direction of the material and/or wherein the after-calcination zone has an internal diameter which reduces at an angle W2 to the vertical of 15° to 50°, in the flow direction of the material.

19. The co-current/counter-current regenerative shaft kiln as claimed in claim 18, wherein the cooling gas removal device comprises a particle separation apparatus for separating material particles from the cooling gas stream.

20. The co-current/counter-current regenerative shaft kiln as claimed in claim 19, wherein the particle separation apparatus is configured as a cooling air channel between the cover and the inner cylinder which opens into the cooling gas inlet.

21. The co-current/counter-current regenerative shaft kiln as claimed in claim 20, wherein the cooling air channel is configured such that the cooling air is deflected at an angle of 90° to 200°.

22. The co-current/counter-current regenerative shaft kiln as claimed in claim 16, wherein the cooling gas removal device is connected to a heat exchanger for heating the offgas.

23. A co-current/counter-current regenerative shaft kiln for burning and cooling material, such as carbonate rock, comprising:
two shafts which are operable alternately as a burning shaft and as a regenerative shaft and are connected to one another by means of a connecting duct;
wherein in the flow direction of the material each shaft comprises a preheating zone for preheating the material, a burning zone for burning the material and a cooling zone for cooling the material;
wherein the cooling zone comprises a cooling gas inlet for admitting cooling gas into the cooling zone and a cooling gas removal device for discharging cooling gas from the shaft, wherein configured downstream of the burning zone in the flow direction of the material is an after-calcination zone which is configured and adapted such that it effects after-calcination of the material exiting the burning zone at a gas temperature of 800° C. to 1100° C., wherein the cooling gas removal device comprises an inner cylinder having a cooling gas inlet and a cover arranged within the cooling zone, wherein the cover is arranged upstream of the cooling gas inlet in the flow direction of the material, wherein the cover has a first hollow-cylindrical region having a constant internal diameter and a length and wherein the ratio of the length to the external diameter of the cooling zone is 0 to 1.

24. A method of burning material, such as carbonate rock, in a co-current/counter-current regenerative shaft kiln having two shafts which are operated alternately as a burning shaft and as a regenerative shaft and are connected to one another by means of a connecting duct, wherein the material flows through a material inlet into a preheating zone for preheating the material, a burning zone for burning the material and a cooling zone for cooling the material to a material outlet, comprising:
admitting a cooling gas into the cooling zone, wherein the cooling gas heated in the cooling zone is discharged from the cooling zone of the shaft via a cooling gas removal device and wherein each shaft is gaseously connected to the connecting duct;
subjecting the material exiting from the burning zone to after-calcination in an after-calcination zone downstream of the burning zone in the flow direction of the material at a gas temperature of 800° C. to 1100° C., wherein a gas separation zone for separating the cooling gas and the fuel gas is configured between the after-calcination zone and the cooling zone, wherein the gas separation zone is configured as an annular space and wherein either the ratio of the internal diameter of the gas separation zone to the external diameter of the cooling zone is 0.4 to 0.9, or the ratio of the length of the gas separation zone to the external diameter of the cooling zone is 0 to 1.

25. The method as claimed in claim 24, wherein the cooling air is introduced into the cooling gas removal device at a temperature of less than 900° C..

26. The method as claimed in claim 24, wherein a cooling gas content of 0.5% to 10% is established in the after-calcination zone.

27. The method as claimed in claim 24, wherein the fuel gas is deflected at an angle of 90° to 180° in the after-calcination zone.

28. The method as claimed in claim 24, wherein the cooling gas discharged from the cooling zone is supplied to a heat exchanger for heating the offgas.
